(19) United States
(12) Patent Application Publication
(10) Pub. No.: US 2007/0106782 A1
(43) Pub. Date: May 10, 2007

(54) BANDWIDTH MANAGEMENT IN EACH NETWORK DEVICE IN A SWITCHED DIGITAL VIDEO ENVIRONMENT

(75) Inventors: William C. Versteeg, Alpharetta, GA (US); William E. Wall, Atlanta, GA (US); Peter G. Briggs, Norcorss, GA (US)

Correspondence Address: SCIENTIFIC-ATLANTA, INC.;INTELLECTUAL PROPERTY DEPARTMENT, 5030 SUGARLOAF PARKWAY, LAWRENCEVILLE, GA, 30044, US

(73) Assignee: SCIENTIFIC-ATLANTA, INC., Lawrenceville, GA (US)

(21) Appl. No.: 11/164,119

(22) Filed: Nov. 10, 2005

(51) Int. Cl. G06F 15/173

(52) U.S. Cl. 709/224

(57) ABSTRACT

Bandwidth management in each network device in a switched digital video environment. Each device in a user's home and the switched digital video (SDV) device can evaluate the bandwidth requirements of a request from any device in the home and compare it to the bandwidth available at the user's home. This is done as the request is passed upstream from device to device. If there is insufficient bandwidth available, an error message is returned to the requesting device.

### CROSS-REFERENCE TO RELATED PATENT APPLICATIONS

The present U.S. application is related to U.S. applications entitled “QUALITY OF SERVICE MANAGEMENT IN A SWITCHED DIGITAL VIDEO ENVIRONMENT” with attorney docket number A-10080, “CHANNEL CHANGES BETWEEN SERVICES WITH DIFFERING BANDWIDTH IN A SWITCHED DIGITAL VIDEO SYSTEM” with attorney docket number A-10081, and “ATOMIC CHANNEL CHANGES IN A SWITCHED DIGITAL VIDEO SYSTEM” with attorney docket number A-10082, which are incorporated herein by reference, and have been filed concurrently with the present application.

### FIELD OF THE INVENTION

This invention relates in general to broadband communications systems, and more particularly, to the use of a switched digital video system to change between services with differing bandwidths in a local home network.

### BACKGROUND

A broadband communications system includes data sources, a broadcasting network, a headend unit, and edge devices. The data sources can be encoders and video sources that send data through an uplink to the broadcasting network. In the broadcasting network, three common types of signals received at the headend include off-air signals, satellite signals, and local origination signals. The satellite signals include any signal transmitted from an earth station to an orbiting satellite which are then retransmitted back down to earth. The signals are transmitted from earth to the orbiting satellite on a path referred to as the uplink. These signals are then received by a transponder on the satellite and are retransmitted from the transponder to a receiving earth station over a downlink. The transponder amplifies the incoming signal and changes its frequency for the downlink journey to avoid interference with uplink signals.

The headend (HE) or central office is where signals from multiple sources are received and are conditioned and prepared for transmission over an access network to subscribers. Once signals have been prepared for delivery, they are combined onto a medium to be sent over the access network to the customer premise devices. Conditioning may include conversion of analog to digital, digital bit-rate conversion, conversion from variable bit rate to constant or clamped bit rate, conversion of multiple-program transport streams to single-program transport streams or any other type of grooming or combination of these. The medium may include coaxial, twisted pair or other cable, optical fiber, or some form of wireless transmission. The preparation for transmission in edge devices may include generation of an RF carrier, modulation, conversion to optical, frequency division multiplexing, time division multiplexing, wavelength division multiplexing or any combination of these. Edge devices vary depending on the type of network, and include the headend output devices. These edge devices sometime overlap with or extend into an access network. The fiber access network can include an optical line terminal (OLT), an optical node terminal (ONT), and devices inside the home. Therefore, the OLT and ONT may be considered either an edge device or an access network device. However, the ONT may at times be considered a customer premises device. A hybrid fiber/coax (HFC) network typically uses modulator edge devices. An HFC access network can include RF to optical converters, optical to RF converters, optical and RF amplifiers, optical and RF combiners, splitters and taps. HFC customer premises devices include RF modems and set-top boxes. A digital subscriber line (DSL) network can include a digital subscriber line access multiplexer (DSLAM). DSL modems are usually located in customer premises. The OLTs, modulators, and DSLAMs, also known as edge devices, service numerous user homes, such as a neighborhood in a city. Customer premise devices can include modems, routers, personal computers, set-top boxes (STB), etc.

FIG. 1 illustrates a satellite broadcast network 100. At an uplink facility 110, program content is stored on video servers controlled by a broadcast automation system. Any analog content at a network operations center (NOC) 120 is compressed using encoders and then multiplexed with the content delivered from the video file servers. The NOC 120 is responsible for overall control and co-ordination of the uplink and the downlink sites. A headend (HE) 130 may include one or more server devices for providing broadband signals such as video, audio, and/or data signals. The headend 130 also has numerous decoders which preferably each have a mass storage device, such as a hard disk drive.

Broadband communications systems, such as satellite and cable television systems and DSL, are now capable of providing many services in addition to analog broadcast video, such as Video-on-Demand (VOD), personal video recording (PVR), HDTV, Interactive TV, Web TV, online gaming, telelearning, video conferencing, voice services, and high speed data services. With an increase in the number of services offered, the demand for bandwidth has drastically increased. A switched digital video (SDV) system is a technique that delivers selected services only to homes where and when users are actively requesting service. The switched digital video technique would be performed in the SDV devices, which vary depending on the type of network. A common problem using the SDV technique is devices in a user's home requesting services requiring more bandwidth than can be provided. The SDV devices can not currently evaluate the bandwidth being requested with the available bandwidth, so an attempt is made to honor all requests. This results in oversubscribing and a loss of packets.

### BRIEF DESCRIPTION OF THE DRAWINGS

The invention can be better understood with reference to the following drawings. The components in the drawings are not necessarily drawn to scale, emphasis instead being placed upon clearly illustrating the principles of the invention. In the drawings, like reference numerals designate corresponding parts throughout the several views.

FIG. 1 illustrates a satellite broadcast system with an uplink, headend, and network operations center.

FIG. 2 illustrates the system of FIG. 1 in combination with a fiber access network and a customer premises network.

FIG. 3 illustrates the system of FIG. 1 in combination with a hybrid fiber/coax access network and a customer premises network.

FIG. 4 illustrates the system of FIG. 1 in combination with a DSL access network and a customer premises network.

FIG. 5 illustrates a services map published by the headend.

FIG. 6 illustrates a group of STBs and PCs in a home.

FIG. 7 illustrates a quality of service priority table for services in a user's home.

FIG. 8 illustrates the prior art method of IGMP based channel changes in a broadcast system, including an error condition.

FIG. 9 illustrates a method of atomic channel change in a broadcast system according to the present invention.

### DETAILED DESCRIPTION

The embodiments of the invention can be understood in the context of a broadband communications system. Note, however, that the invention may be embodied in many different forms and should not be construed as limited to the embodiments set forth herein. For example, transmitted broadband signals may include at least one of video/audio, telephony, data, or Internet Protocol (IP) signals, to name but a few. All examples given herein, therefore, are intended to be non-limiting and are provided in order to help clarify the description of the invention.

A switched digital video system is a method of maximizing the number of services offered using a minimum of bandwidth. The switched digital video system allows chosen services from the HE 130 or central office to continually be sent to the subscriber premises, or the user's home, and other services to be switched in as requested by the user. For example, in a cable television system, a specified group of popular television channels is continually sent to every home in an access network subdivision regardless of what the user may want. When a user requests a channel not in this specified group, it is first checked to see if anyone else in the service group is watching the requested channel. If yes, then the requesting user is given access to the stream already carrying the requested channel. If not, the switch provides the requested stream to the required edge device and the system gives the requesting subscriber access to that stream. A switched digital video system can be used on many types of networks such as fiber, hybrid fiber/coax, and xDSL networks.

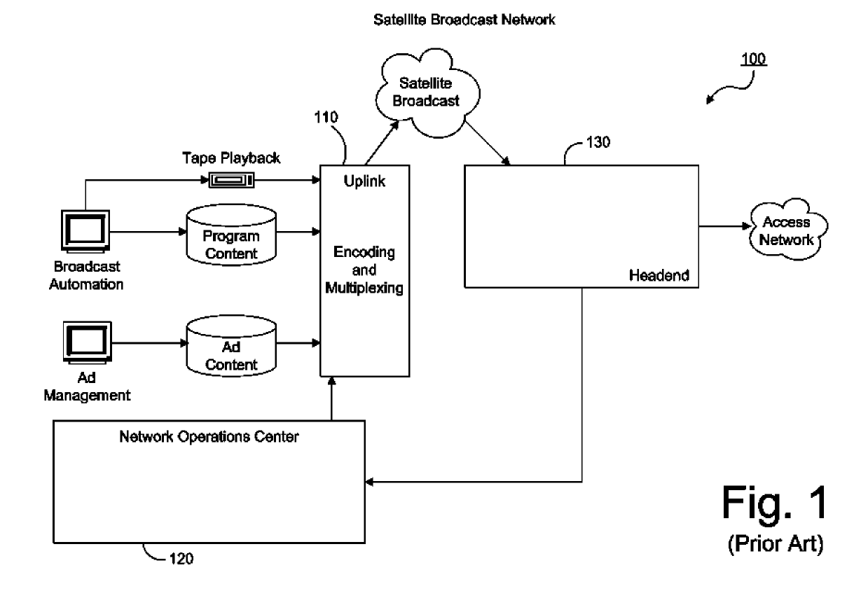

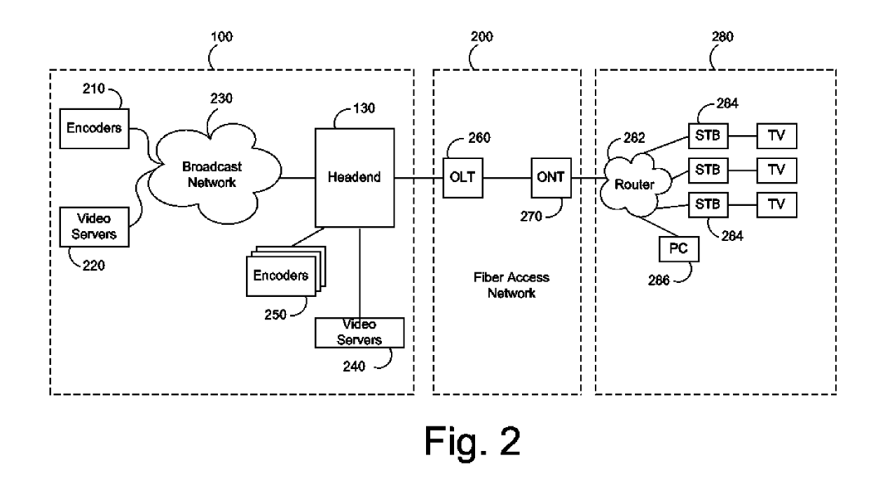

FIG. 2 illustrates the satellite broadcast system 100 of FIG. 1 in combination with a fiber access network 200 and a customer premises network 280. Encoders 210 and video servers 220 are the data sources that feed a broadcast network 230 of the satellite broadcast system 100. Video servers 240 and encoders 250 located at the HE 130 are used to insert local programming. The HE 130 of the satellite broadcast system 100 receives signals from multiple sources, conditions them and prepares them for transmission over the access network 200. Once signals have been prepared for transmission from the HE 130, they are combined onto the access network media. In a fiber access network 200 an optical line terminal (OLT) 260 transmits downstream to optical network terminals (ONT) 270 which are located outside the customer premises network 280. The OLT 260 is responsible for allocating necessary upstream bandwidths to the ONTs 270 by issuing data grants in an appropriate manner. Inside the customer premises network 280, the signals can be split and combined using a router 282, or other device, and then fed to various devices, such as one or more set-top boxes (STBs) 284 or personal computers (PCs) 286.

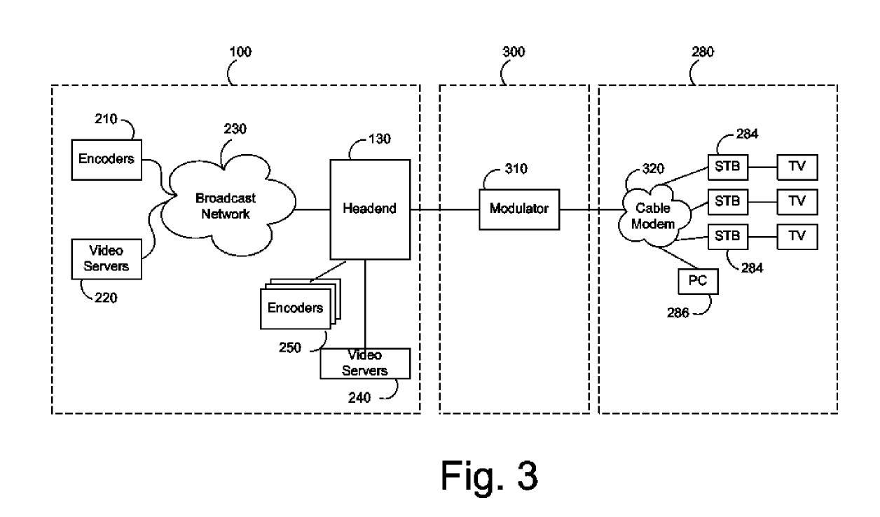

FIG. 3 illustrates the satellite broadcast system 100 of FIG. 1 in combination with a hybrid fiber/coax (HFC) access network 300 and the customer premises network 280. The components used for the HFC access network 300 are similar to those used for the fiber access network 200. However, instead of the OLT 260 and the ONT 270, the hybrid fiber/coax network 300 uses an edge modulator 310. Inside the customer premises network 280, the signal is received by a cable modem 320 and sent to various devices, such as one or more STBs 284 or PCs 286. RF STBs may interface to the HFC access network 300 directly using internal modems.

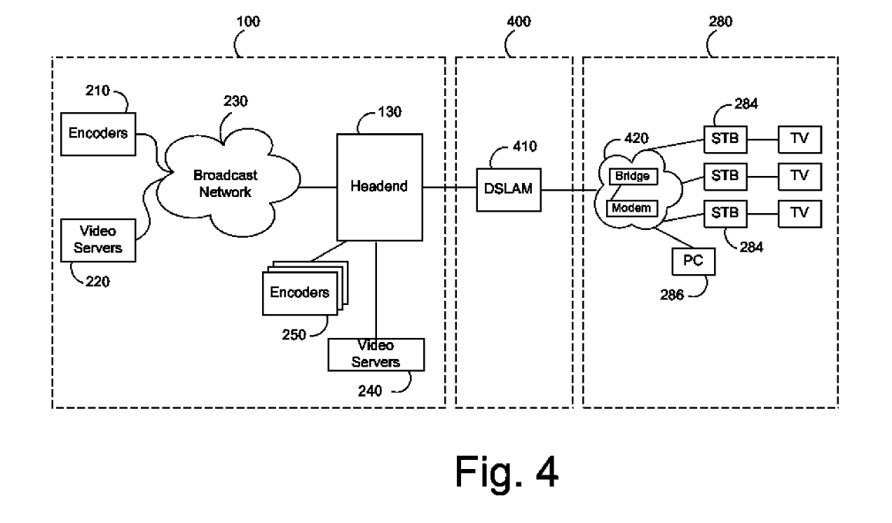

FIG. 4 illustrates the satellite broadcast system 100 of FIG. 1 in combination with a DSL access network 400 and the customer premises network 280. The components used for the DSL access network 400 are similar to those used in the fiber access network 200 and the HFC access network 300 except for the edge devices. Instead of the OLT 260 and the ONT 270 or the modulator 310, the DSL access network 400 has a digital subscriber line access multiplexer (DSLAM) 410 that links numerous users to a single high-speed ATM line. Inside the customer premises network 280, the signal is received by a local network 420 possibly containing a modem and bridge router. The signal is split there and fed to various devices, such as one or more STBs 284 or PCs 286.

The switched digital video technique would be performed in SDV devices, such as the OLT 260, DSLAM 440, modulator 340 or a router feeding the modulator 340, depending on the type of network. A common problem using the SDV technique occurs when devices in a user's home request services requiring more aggregate bandwidth than can be provided. The SDV devices can not currently track the bandwidth being requested, so an attempt is made to honor all requests. This results in oversubscribing and a loss of packets.

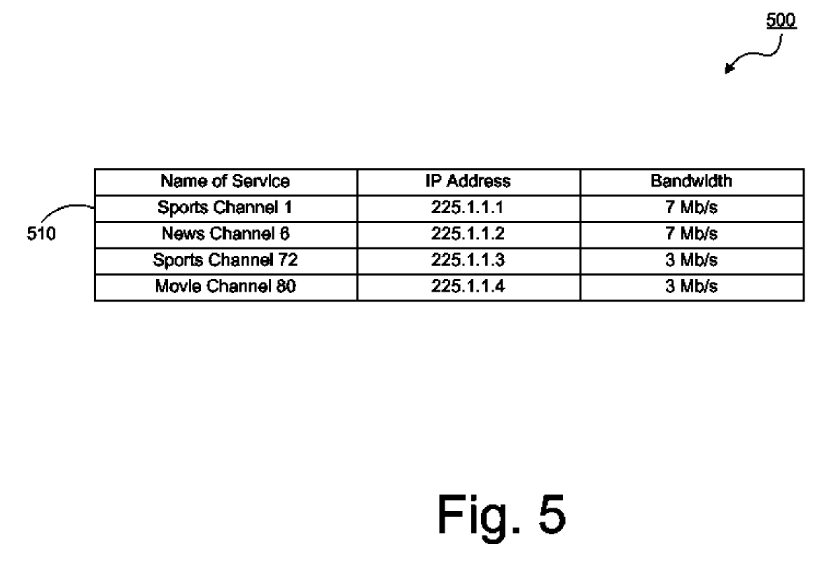

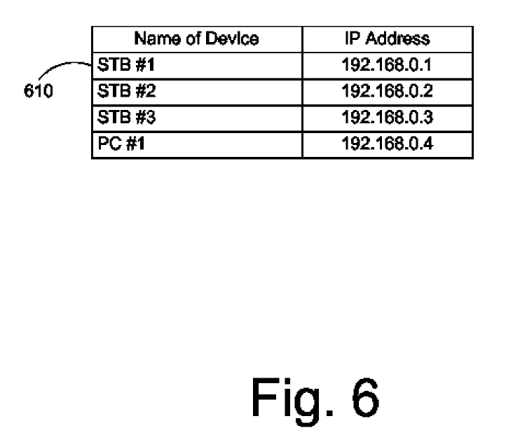

When a device in the user's home requests a change in service that will affect the bandwidth required, the change will be subject to a system resource management validation. For SDV devices to evaluate bandwidth requests and availability, the HE 130 can publish a services map 500, as shown in FIG. 5, prepared by the system operator. The map will be put in a multicast group, which is a group of different services, and the STB in the home will know to join the multicast containing the services map first. The STB will then distribute the map to the other devices in the home. As shown in FIG. 6, each SDV device and each device in the home will have an identifier, such as an IP address, which will allow them to differentiate themselves from one another. The devices in the home will use the information in the services map to provide the SDV devices with the requesting IP address and the required bandwidth. For example, STB number 1 with reference number 610 is located at IP address 192.168.0.1 and is tuned to the service “Sports Channel 1” shown as reference number 510 at IP address 225.1.1.1 requiring 7 Mb/s of bandwidth. The SDV devices have the ability to evaluate the request from the devices in the home by comparing the requested bandwidth to the available bandwidth for the subscriber premises. The SDV devices can either grant or deny the service in order to prevent oversubscription and a loss of packets.

In another embodiment, the SDV devices and all the devices in the users' home can correlate a request for service to the bandwidth available to each home. A bandwidth management status is the required bandwidth of a request correlated to the available bandwidth in the home. Each device has its own upper limit or choke point. The SDV devices and the home devices parse the service request packets before sending them upstream and adding their bandwidth management status (the requested bandwidth correlated to the available bandwidth) to the request. If any device does not have adequate bandwidth, it sends a message to the requesting device indicating an error condition.

Internet group management protocol (IGMP) is a standard used to communicate between an IP host, such as the SDV devices, and the neighborhood multicast agents to support allocation of temporary group addresses and the addition and deletion of members of the group. In this embodiment, the bandwidth can be managed by having a field in the IGMP request for adding the bandwidth management status at each intervening point, or at each device. In normal IGMP, only the IGMP endpoint is an active component. In this embodiment, however, the IGMP endpoint, the SDV device, and any of the devices in the user's home can read and evaluate the incoming requests in order to deny or pass on the request upstream.

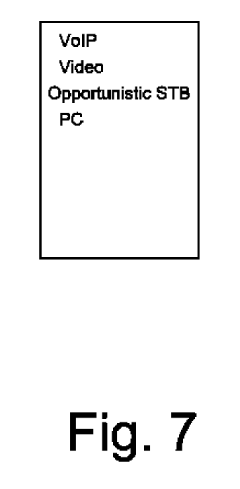

In the event of oversubscription, it is possible to place a quality of service (QOS) priority status on each request. This QOS priority status scheme is set up by the system operator. As the IGMP request passes from device to device, each device needs to be able to specify the required QOS for the requested stream. For example as shown in FIG. 7, in a multicast group, voice over IP (VOIP) streams may require a higher priority than video which has a higher priority than web surfing, which is an opportunistic STB function.

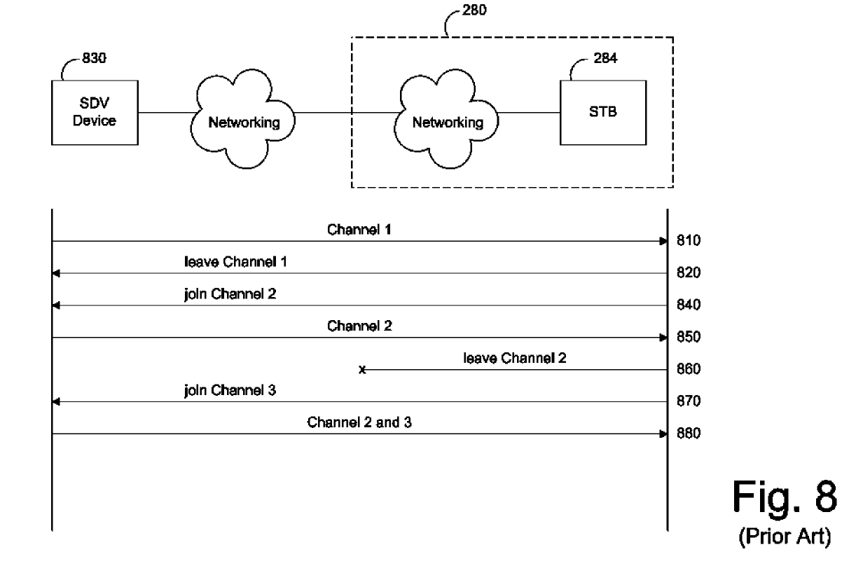

FIG. 8 illustrates the current method of IGMP based channel changes in a broadcast system. Joining and leaving multicast groups are currently two independent transactions. The joining message is a request for a new channel and the leaving message is a request to terminate a current channel. For example, if a user is currently watching channel 1, as shown in reference number 810, and wants to watch channel 2, then a channel change must occur. First, a “leave channel 1” transaction 820 is sent to a SDV device 830. Then, a “join channel 2” transaction 840 is also sent to the SDV device 830. Channel 2, shown in reference number 850, is now being sent to a STB 284 in the user's home 280. This is a correct channel change.

Either of these transactions can be dropped by the network. A dropped transaction can lead to oversubscription. For example, if a user wants to change channels from channel 2 to channel 3, a “leave channel 2” transaction 860 is sent to the SDV device 830. If the transaction 860 is dropped, then channel 2 is still being sent to the STB 284. A “join channel 3” transaction 870 is also sent to the SDV device 830. The SDV device 830 will attempt to send both channels 2 and 3, as shown in reference number 880, which will cause an oversubscription.

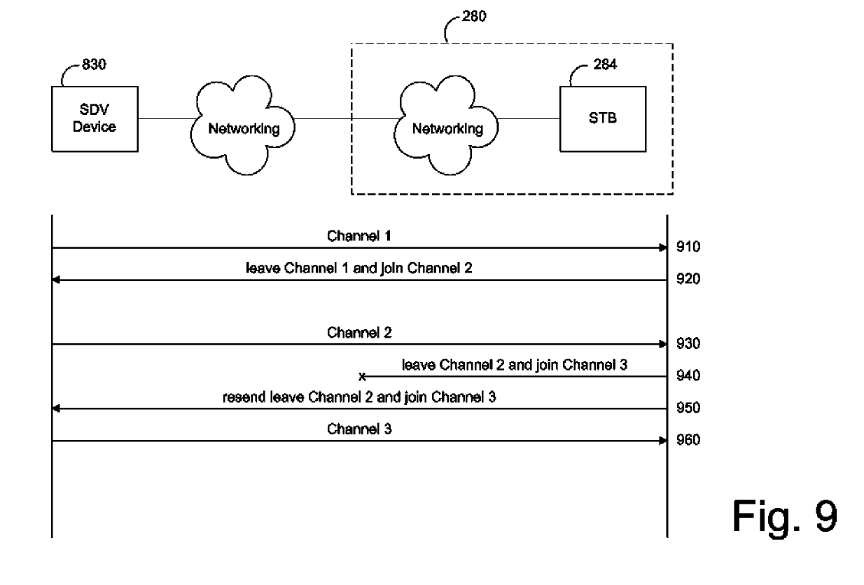

FIG. 9 illustrates a method of atomic channel change in a broadcast system according to the present invention. In this embodiment, a new IGMP message is defined that explicitly lists the streams that the STB 284 wants to receive and simultaneously requests a join and leave transaction. For example, if a user is currently watching channel 1, shown in reference number 910, and decides to watch channel 2, then a channel change must occur. The STB 284 sends a message to the SDV device 830 that contains a “leave channel 1 and join channel 2” transaction 920. Channel 2, shown in reference number 930, is now being sent to the STB 284 in the user's home 280. This is a correct channel change. Also, if a user wants to change channels from channel 2 to channel 3, a “leave channel 2 and join channel 3” transaction 940 is sent to the SDV device 830. If the transaction 940 is dropped, then no change occurs and, because STB 284 never received channel 3, the STB 284 resends the “leave channel 2 and join channel 3” in transaction 950. The STB 284 may wait to receive channel 3 for a specified period of time before resending the “leave channel 2 and join channel 3” transaction 950. Alternately, if the user reiterates the channel change request, the STB 284 may resend the “leave channel 2 and join channel 3” transaction 950. The SDV device 830 is now sending channel 3, as shown in reference number 960, to the STB 284.

IGMP messages, such as join and leave messages, can be updated or modified to include bandwidth requirements of both the join and leave channels. For example, channel 1, as shown in reference number 910, may require a bandwidth of 3 Mb/s and channel 2, as shown in reference number 930, may require a bandwidth of 6 Mb/s. The SDV device can compare the available bandwidth in the local network to the required bandwidth for channel 2 before performing the channel change. This would allow the SDV devices to more accurately determine which services can be sent to a user's home without oversubscription occurring and return an error message to the requesting device if service is not possible.

The numerous services offered by broadband communications systems continue to grow. With an increase in the number of services offered and the number of users subscribing, the demand for bandwidth has drastically increased. The SDV technique, described above, delivers selected services only to homes where and when users are actively requesting service, which helps to efficiently manage the available bandwidth. To make this more effective, each device in the local network can calculate the available bandwidth versus the bandwidth requested for a service. By sending an error message if the service cannot be provided, there is no loss of packets or disrupted service.

It should be emphasized that the above-described embodiments of the invention are merely possible examples, among others, of the implementations, setting forth a clear understanding of the principles of the invention. Many variations and modifications may be made to the above-described embodiments of the invention without departing substantially from the principles of the invention. All such modifications and variations are intended to be included herein within the scope of the disclosure and invention and protected by the following claims. In addition, the scope of the invention includes embodying the functionality of the embodiments of the invention in logic embodied in hardware and/or software-configured mediums.

What is claimed is:

1. A system for receiving and evaluating requests for at least one of services and channels, said system comprising:
one or more home devices at a plurality of subscriber premises;
a switched digital video (SDV) device for connecting said subscriber premises to a broadcast network;
at least one of said devices receives said request, said one device evaluates said request by comparing bandwidth requirements of said request to available bandwidth of one of said subscriber premises.

2. The system of claim 1, wherein said at least one device is at least one of said home devices adapted to either grant said request because said bandwidth requirements are within said available bandwidth and deny said request when bandwidth requirements of said request exceed said available bandwidth to said one subscriber premises.

3. The system of claim 1, wherein said at least one device is at least one of said SDV devices adapted to either grant said request because said bandwidth requirements are within said available bandwidth and deny said request when bandwidth requirements of said request exceed said available bandwidth to said one subscriber premises.

4. The system of claim 1, wherein said at least one device denies one of said requests because the bandwidth requirement of one said request exceeds said available bandwidth.

5. The system of claim 1, wherein said at least one device grants one of said requests because the bandwidth requirement of one said device is within said available bandwidth.

6. The system of claim 1, wherein at least one device grants one of said request because the bandwidth requirement of one said request is within said available bandwidth through one said device and, wherein another of said devices compares bandwidth requirements of said request to available bandwidth.

7. The system of claim 6, wherein said another of said devices grants one of said requests because the bandwidth requirement of one said request exceeds said available bandwidth.

8. The system of claim 6, wherein said another of said devices denies one of said request because the bandwidth requirement of one said request exceeds said available bandwidth.

9. The system of claim 6, wherein said one device is a home device and said other device is a SDV device.

10. The system of claim 6, wherein said one device and said other device are home devices.

11. The system of claim 1, wherein said SDV devices are one of a digital subscriber line access multiplexer (DSLAM), a digital content manager (DCM), or an optical line terminal (OLT).

12. A method for receiving and evaluating a request for at least one of services and channels, said method comprising the steps of:
connecting a plurality of subscriber premises to a broadcast network with a switched digital video (SDV) device;
connecting one or more devices in each of said subscriber premises to said SDV device;
receiving at one of said devices a request for at least one of said services or channels; and
evaluating said request by comparing said bandwidth requirement of said request to available bandwidth of one of said subscriber premises.

13. The method of claim 12, further comprising the step of denying said request because the bandwidth requirement of said request exceeds said available bandwidth.

14. The method of claim 12, further comprising the step of granting said request because the bandwidth requirement of said request is within said available bandwidth.

15. The method of claim 12, further comprising the steps of at least one device granting said request because the bandwidth requirement of said request is within said available bandwidth through one said device and, wherein another of said devices compares bandwidth requirements of said request to available bandwidth.

16. The method of claim 15, further comprising the step of updating a current status of said request.

17. The method of claim 15, wherein the step of updating said current status of said request comprises updating bandwidth requirement of said request.

18. The method of claim 15, wherein the step of updating said current status of said request comprises updating said available bandwidth.

19. The method of claim 15, further comprising the step of another of said devices granting said request because the bandwidth requirement of said request exceeds said available bandwidth.

20. The method of claim 15, further comprising the step of another of said devices denying said request because the bandwidth requirement of said request exceeds said available bandwidth.

21. The method of claim 12, wherein said step of receiving a request comprises a request to implement a channel change by leaving a current channel and joining a requested channel.

22. The method of claim 21, further comprising the steps of terminating said current channel and transmitting said requested channel.

23. The method of claim 12, further comprising the step of updating a current status of said request.

24. The method of claim 23, wherein the step of updating said current status of said request comprises updating bandwidth requirement of said request.

25. The method of claim 23, wherein the step of updating said current status of said request comprises updating said available bandwidth.
